(19) United States
(12) Patent Application Publication
(10) Pub. No.: US 2002/0112218 A1
(43) Pub. Date: Aug. 15, 2002

(54) Delay time calculating method by delay equivalent circuit

(76) Inventors: Kazuyuki Nakamura, Tokyo (JP); Patrick Lenoir, Tokyo (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 09/845,772

(22) Filed: May 2, 2001

(30) Foreign Application Priority Data
Nov. 8, 2000 (JP) 2000-340594

(51) Int. Cl. G06F 17/50

(52) U.S. Cl. 716/6

(57) ABSTRACT

There is provided a delay time calculation method, which simplifies a delay time calculation of an interconnection wiring which includes inductance, within a semiconductor integrated circuit, so that the calculation can be executed by use of the delay time calculating CAD tool used in the prior art.

A delay time of a wire model consisting of three components of inductance (L), capacitance (C) and resistance (R), is obtained by an analysis equation and an approximation calculation, and a circuit consisting of a second resistance (R′) and a second capacitance (C′) and having a delay time equivalent to the delay time obtained is imaginarily constructed. The delay time is calculated by using the value of the second resistance (R′) and the value of the second capacitance (C′) obtained in this method.

### BACKGROUND OF THE INVENTION

The present invention relates to a design of a semiconductor integrated circuit, and more specifically to a delay equivalent circuit in a wire model which includes inductance, for a large scaled integrated circuit.

A calculation of a signal delay time in a signal interconnection wiring within a large scaled integrated circuit (LSI), has been carried out in the prior art by considering only a resistance component and a capacitance component of the interconnection wiring. This method of calculating the delay time of the signal interconnection wiring in a model consisting of a resistance and a capacitance, is currently widely used since the wiring delay time can be fundamentally easily calculated by the product of the resistance and the capacitance. A computer aided design (CAD) tool dedicated for the delay calculation, which can speedily calculate the wiring delay time on the basis of design data of the LSI in accordance with this method, is also widely used.

FIG. 1 shows a wire model consisting of a resistance and a capacitance. In the circuit shown in FIG. 1, a delay time of an interconnection wiring from an input terminal (IN) to an output terminal (OUT) is proportional to the product of R and C, and is expressed as follows:

t_{d}(RC)=τIn(2) (1)

However, with an increasing speed of the LSI, it has become necessary to consider an inductance component of the interconnection wiring in the calculation of the wiring delay time in the LSI which were sufficient if the resistance and the capacitance are considered. If the inductance is considered, another problem is encountered in which the calculation of the wiring delay time become complicated, and on the other hand, it becomes impossible for the conventional CAD tool for the wiring delay time to calculate, so that an analog circuit simulator must be used.

### BRIEF SUMMARY OF THE INVENTION

Accordingly, it is an object of the present invention to provide a delay time calculation method, which has overcome the above mentioned problem of the prior art, and which simplifies a delay time calculation of an interconnection wiring which includes inductance, within a semiconductor integrated circuit, thereby to make it possible to use the CAD tool used in the prior art for the wiring delay time calculation.

In order to achieve the above mentioned object, a delay time calculation method in accordance with the present invention is characterized in that in a wire model consisting of three components of inductance L, capacitance C and resistance R, a second resistance R′ and a second capacitance C′ are obtained by an analysis equation and an approximation calculation, and the wiring delay time is calculated by using an equivalent circuit consisting of the second resistance R′ and the second capacitance C′.

Thus, even in a situation which is not allowed to ignore the influence of the inductance, it becomes possible to calculate the delay time on the basis of R′ and C′ by use of the conventional CAD tool used in the prior art, so that the design cost and the design time of LSI can be reduced.

One embodiment of the delay time calculation method in accordance with the present invention is characterized in that the value of the second capacitance C′ is the same as the value of the first mentioned capacitance C. Thus, in the design of a circuit in which a charging/discharging of the capacitance is prevailing, it becomes possible to calculate the delay time while avoiding influence to a consumed power calculation, and furthermore, the design cost and the design time of LSI can be reduced.

A preferred embodiment of the delay time calculation method in accordance with the present invention is characterized in that the above mentioned second resistance R′ is expressed as follows:

$${R}^{′} = \frac{{Z}_{0}}{ln ( 2 )} \{ {x}_{0} + {x}_{1} ( m - 1 ) + {{x}_{2} ( m - 1 )}^{2} \}$$

where the dumping factor “m”:

$$m = \frac{R}{2} \sqrt{\frac{C}{L}}$$

$${Z}_{0} = \sqrt{\frac{L}{C}}$$

$${x}_{0} = 1.6783$$

$${x}_{1} = 0.9389$$

$${x}_{2} = 0.3489$$

Thus, it is possible to directly obtain the value of R′ from the values of R, L and C by use of a simple calculation, and therefore, the design cost and the design time of LSI can be further reduced.

In a further preferred embodiment of the delay time calculation method in accordance with the present invention, the above mentioned dumping factor “m” is in the range of 0.109<m<1.

With this arrangement, the range in which the delay time can be precisely calculated by use of the method for calculating the second resistance R′ in the preferred embodiment of the delay time calculation method in accordance with the present invention, becomes definite.

According to the present invention, there is provided a recording medium which stores a program for causing a computer to execute procedures in the delay time calculation method in accordance with the present invention, and which can be read by the computer. Thus, the delay time calculation method in accordance with the present invention can be executed by a computer, so that the design cost and the design time of LSI can be reduced.

### BRIEF DESCRIPTION OF THE DRAWINGS

FIG. 1 is a conventional delay circuit diagram consisting of resistance and capacitance;

FIGS. 2A and 2B are circuit diagrams for illustrating an embodiment of the delay time calculation method in accordance with the present invention;

FIG. 3 shows a circuit for illustrating a method for calculating the delay time of a delay circuit consisting of inductance, resistance and capacitance, and corresponding items of the calculation equation;

FIGS. 4A, 4B and 4C are an input signal waveform and output signal waveforms of two different delay circuits;

FIG. 5 is an output signal waveform in the case that the dumping factor is less than 1;

FIG. 6 is an output signal waveform in the case that the dumping factor is larger than 1; and

FIGS. 7A, 7B and 7C illustrate examples of the delay times obtained by using R′ and C′ obtained in accordance with the present invention.

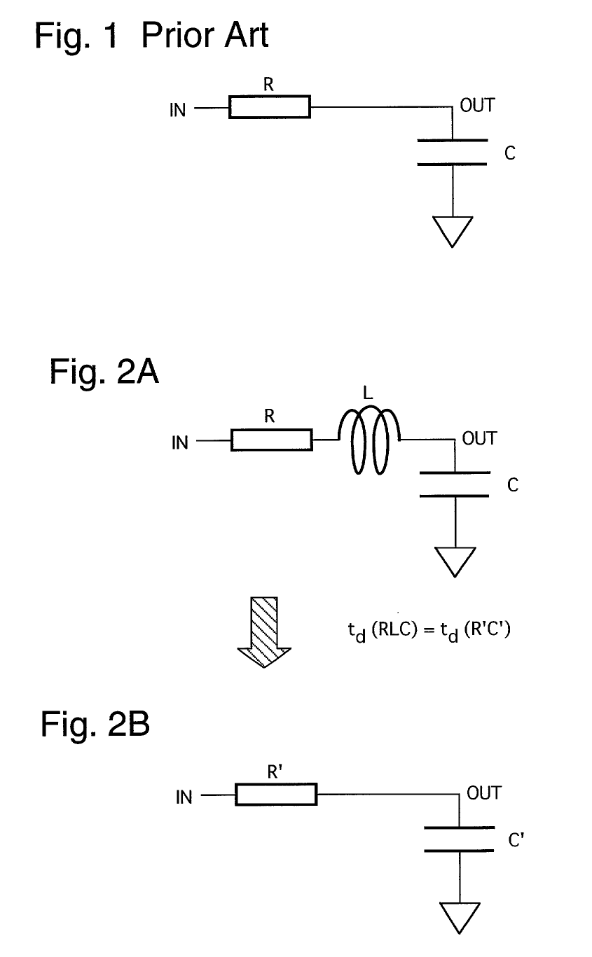

### DETAILED DESCRIPTION OF THE INVENTION

Now, an embodiment of the delay time calculation method in accordance with the present invention will be described with reference to the drawings. In order to make it possible to use a conventional CAD tool which executes the delay calculation on the basis of only resistance and capacitance, even in an interconnection wiring whose inductance should be considered, a circuit having a wiring delay time {t_{d}(RLC)} determined by L, R and C, shown in FIG. 2A, is converted once into a virtual equivalent circuit (RC equivalent delay circuit) consisting of resistance (R′) and capacitance (C′) and having a delay time {t_{d}(R′C′)} determined by the product of resistance and capacitance, similarly to the conventional example, as shown in FIG. 2B, and then, the resistance value R′ and the capacitance value C′ are obtained.

For this purpose, a delay time of a wire model consisting of three components of inductance L, capacitance C and resistance R, is obtained by an analysis equation or an approximation calculation, and a circuit is imaginarily constructed which has a delay time equivalent to the delay time thus obtained and which consists of two components of a different resistance R′ and a different resistance C′. Then, the delay time is calculated by using the value of R′ and the value of C′ thus obtained.

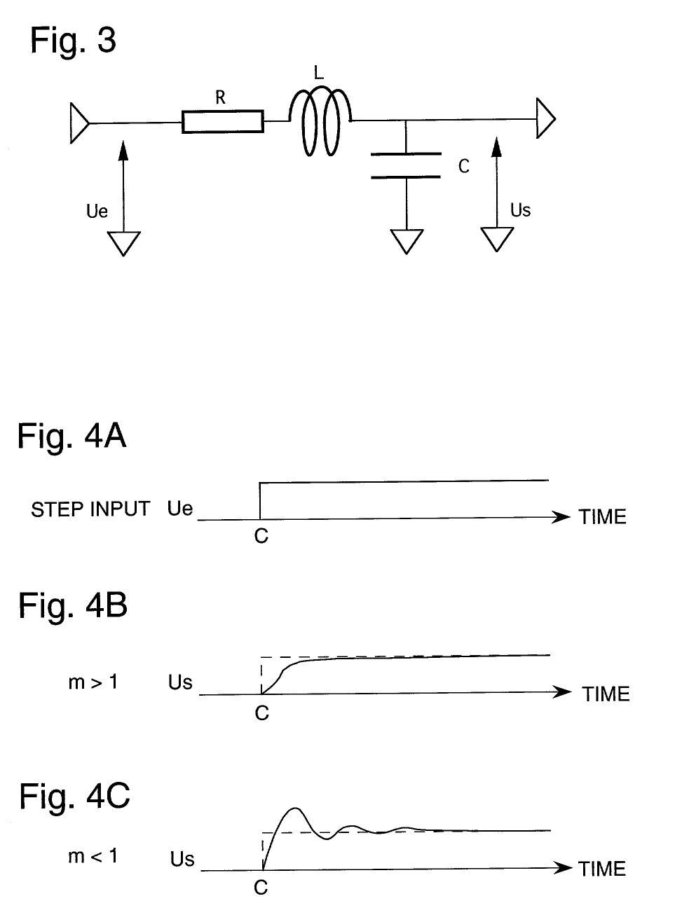

A wire model including the inductance (L) shown in FIG. 2A is shown in FIG. 3. In the drawing, “Ue” indicates an input voltage, and “Us” denotes an output voltage.

A time-differential equation is expressed as follows by using the inductance (L), the resistance (R) and the capacitance (C):

LCÜs+RC\dot{U}s+Us=Ue (2)

By using the relation of ω₀=1/\sqrt{LC} and the dumping factor of

$$m = \frac{R}{2} \sqrt{\frac{C}{L}} ,$$

, this equation is modified as follows:

Üs+2mω₀\dot{U}s+ω₀²Us=ω₀²Ue (3)

In this case, a waveform appearing on the output terminal assumes two greatly different patterns, dependently upon the value of the dumping factor “m” obtained in the relation of L, C and R.

FIGS. 4A, 4B and 4C illustrate a change with time of the output voltage Us when a step input Ue is applied. In the following, it is assumed that the input voltage is the step input Ue and the step input Ue is standardized to “1”.

The change of the step input voltage is shown in FIG. 4A. When the dumping factor “m” is larger than “1”, the output voltage changes as shown in FIG. 4B, and when the dumping factor “m” is smaller than “1”, the output voltage changes as shown in FIG. 4C.

When the dumping factor “m” is larger than “1”, the waveform is similar to that in a model consisting of only the resistance and the capacitance, but when the dumping factor “m” is smaller than “1”, the inductance starts to influence the delay.

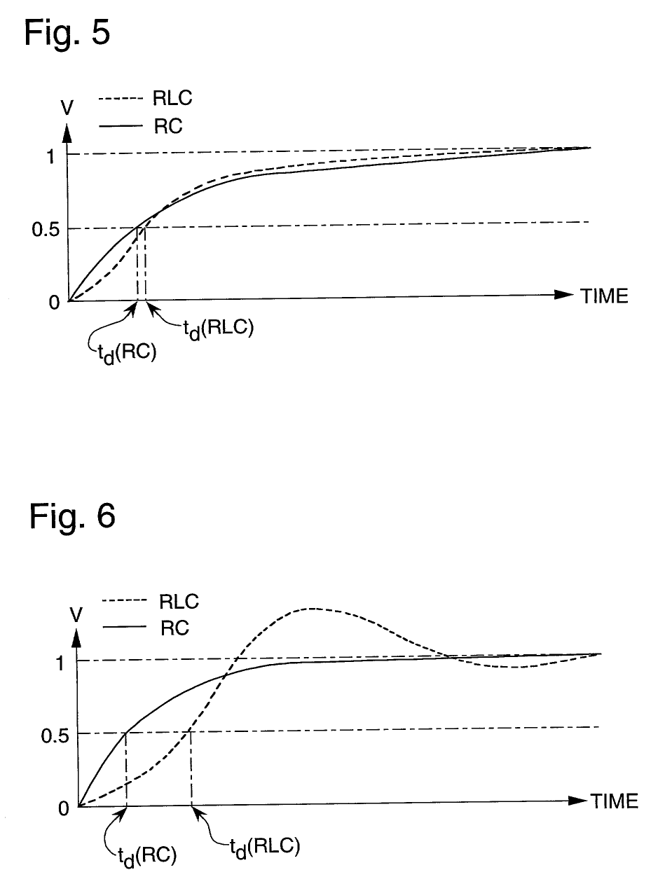

FIG. 5 shows two waveforms when the dumping factor “m” is larger than “1”. In the drawing, “RC” (solid line) shows the waveform obtained from only R and C by neglecting the inductance, and “RLC” (dotted line) shows the waveform obtained from R, L and C by considering the inductance.

Here, the lapse of time until the output voltage Us reaches a half (0.5) of the input voltage, is defined as the time t_{d}(RC) and the time t_{d}(RLC). In the case that the dumping factor “m” is larger than “1” as shown in FIG. 5, a difference between the time t_{d}(RC) and the time t_{d}(RLC) is small, and therefore, there is no problem even if the delay time is calculated by approximating to the RC circuit by neglecting the inductance.

FIG. 6 shows two waveforms when the dumping factor “m” is smaller than “1”. In the drawing, “RC” (solid line) shows the waveform obtained from only R and C by neglecting the inductance, and “RLC” (dotted line) shows the waveform obtained from R, L and C by considering the inductance.

Here, the lapse of time until the output voltage Us reaches a half (0.5) of the input voltage, is defined as the time t_{d}(RC) and the time t_{d}(RLC). In the case that the dumping factor “m” is smaller than “1” as shown in FIG. 6, a difference between the time t_{d}(RC) and the time t_{d}(RLC) is large, and therefore, it is unallowable to calculate the delay time by approximating to the RC circuit by neglecting the inductance.

Here, if the differential equation (3) is solved, the following is obtained:

$$Us ( t ) = 1 - \{ cos [ {ω}_{0} t \sqrt{1 - {m}^{2}} ] + \frac{m}{\sqrt{1 - {m}^{2}}} sin [ {ω}_{0} t \sqrt{1 - {m}^{2}} ] \} {ⅇ}^{- {mω}_{0} t} \qquad ( 4 )$$

Since this is the case of m<1, it can be converted as follows:

$$Us ( t ) = 1 + \{ ( - 1 - {ω}_{0} t ) - \frac{1}{3} {ω}_{0}^{3} {t}^{3} ( m - 1 ) + [ \frac{1}{6} {ω}_{0}^{4} {t}^{4} - \frac{1}{30} {ω}_{0}^{5} {t}^{5} ] {( m - 1 )}^{2} + … \} {ⅇ}^{{ω}_{0} t} \qquad ( 5 )$$

The delay time t_{d}(RLC) until it becomes Us=0.5, is obtained as follows from the equation (5):

$${t}_{d} ( RLC ) = \frac{{x}_{0}}{{ω}_{0}} + \frac{{x}_{1}}{{ω}_{0}} ( m - 1 ) + \frac{{x}_{2}}{{ω}_{0}} {( m - 1 )}^{2} + \qquad ( 6 )$$

At this time, it is

x₀=1.6783 . . . ,

x₁=0.9389 . . . ,

x₂=0.3489 . . . .

By using τ=RC, the equation (6) can be modified as follows:

$${t}_{d} ( RLC ) ≅ τ \{ \frac{{x}_{0}}{2} \frac{1}{m} + \frac{{x}_{1}}{2} \frac{( m - 1 )}{m} + \frac{{x}_{2}}{2} \frac{{( m - 1 )}^{2}}{m} \} \qquad ( 7 )$$

Here, by using R′ and C′, the equation (1) can be expressed:

t_{d}(RLC)=t_{d}(R′C′)=τln(2)=R′C′ln(2) (8)

Accordingly, assuming C′=C, and

$${Z}_{0} = \sqrt{\frac{L}{C}} ,$$

the following is obtained:

$${R}^{′} = \frac{{Z}_{0}}{ln ( 2 )} \{ {x}_{0} + {x}_{1} ( m - 1 ) + {{x}_{2} ( m - 1 )}^{2} \} \qquad ( 9 )$$

Now, the feature of R′ and C′ obtained as mentioned above will be described.

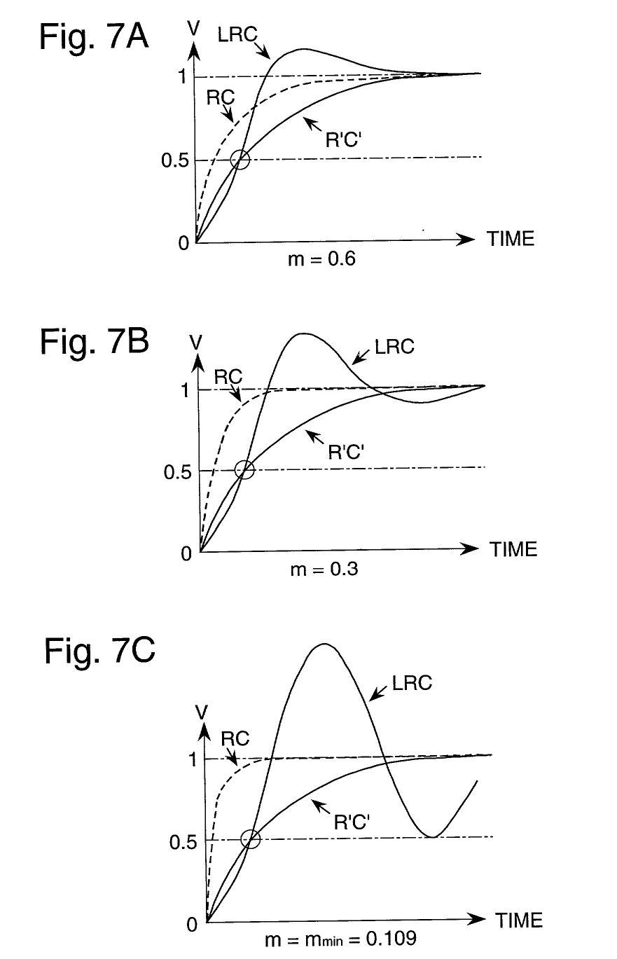

FIGS. 7A, 7B and 7C illustrate the change with time of the output voltage Us of a RC circuit, a RLC circuit and a R′C′ circuit, in the dumping factors of m=0.6, m=0.3 and m=0.109.

Examining the delay time until the output voltage reaches a half of the input voltage, t_{d}(RLC) considering the inductance and t_{d}(R′C′) in proportion to the product of R′ and C′ are the same, but are different from t_{d}(RC) neglecting the inductance.

Namely, it would be understood that, by using R′ and C′ obtained by the equation (8), the delay circuit consisting of three components of inductance L, resistance R and capacitance C, can be converted into a delay circuit which consisting of two components of the resistance R′ and the capacitance C′ and which has a similar delay time.

In addition, in the equation (8), the value of C′ is deemed to be the same as the value of C. By making the value of C′ equal to the value of C, it is possible to make the delay time the same as that of the delay circuit including the inductance, while avoiding influence to a consumed power calculation in the case that a charging/discharging of the capacitance is prevailing.

FIG. 7C shows the case of the dumping factor of m=0.109. This is a lower limit in which R′ and C′ obtained by the equation (8) can be applied to t_{d}(R′C′). If the dumping factor becomes smaller than this value, when the equation (6) is converted into the equation (7), terms of third and succeeding orders become required to be considered.

However, in the case of 0.109<m<1, by using R′ expressed in the equation (8), the result similar to that of the calculation of the delay time considering the inductance, can be derived from R′ and C′.

As mentioned above, by utilizing the circuit in accordance with the present invention, it is possible to simply a delay time calculation of an interconnection wiring which includes inductance, within a semiconductor integrated circuit, thereby to become to utilize the conventional CAD tool which calculates the delay time with only the resistance and the capacitance. Therefore, it is possible to avoid increase of the LSI design cost and increase of the LSI design time.

Finally, in order to assist the understanding of the present invention, Patrick Lenoir and Kazuyuki Nakamura, “An accurate RLC interconnection delay calculation for generating RC delay equivalent circuit enclosing inductance effects”, Technical Report of IEICE, ICD2000-18 (2000-05), pp19-25, is incorporated by reference in its entirety into this application.

1. A delay time calculation method in that in a wire model consisting of three components of inductance L, capacitance C and resistance R, a second resistance R′ and a second capacitance C′ are obtained by an analysis equation and an approximation calculation, and a wiring delay time is calculated by using an equivalent circuit consisting of the second resistance R′ and the second capacitance C′.

2. A delay time calculation method claimed in claim 1 wherein the value of the second capacitance C′ is the same as the value of the first mentioned capacitance C.

3. A delay time calculation method claimed in claim 2 wherein the second resistance R′ is expressed as follows:
$${R}^{′} = \frac{{Z}_{0}}{ln ( 2 )} \{ {x}_{0} + {x}_{1} ( m - 1 ) + {{x}_{2} ( m - 1 )}^{2} \}$$
where the dumping factor “m”:
$$m = \frac{R}{2} \sqrt{\frac{C}{L}}$$
$$\begin{matrix}{Z}_{0} = \sqrt{\frac{L}{C}} \\ {x}_{0} = 1.6783 … \\ {x}_{1} = 0.9389 … \\ {x}_{2} = 0.3489 …\end{matrix} .$$

4. A delay time calculation method claimed in claim 3 wherein the dumping factor “m” is in the range of 0.109<m<1.

5. A delay time calculation method claimed in claim 1 wherein the second resistance R′ is expressed as follows:
$${R}^{′} = \frac{{Z}_{0}}{ln ( 2 )} \{ {x}_{0} + {x}_{1} ( m - 1 ) + {{x}_{2} ( m - 1 )}^{2} \}$$
where the dumping factor “m”:
$$m = \frac{R}{2} \sqrt{\frac{C}{L}}$$
$$\begin{matrix}{Z}_{0} = \sqrt{\frac{L}{C}} \\ {x}_{0} = 1.6783 … \\ {x}_{1} = 0.9389 … \\ {x}_{2} = 0.3489 …\end{matrix} .$$

6. A delay time calculation method claimed in claim 5 wherein the dumping factor “m” is in the range of 0.109<m<1.

7. A recording medium which can be read by a computer and which stores a program for causing the computer to execute procedures in a delay time calculation method in that in a wire model consisting of three components of inductance L, capacitance C and resistance R, a second resistance R′ and a second capacitance C′ are obtained by an analysis equation and an approximation calculation, and a wiring delay time is calculated by using an equivalent circuit consisting of the second resistance R′ and the second capacitance C′.

8. A recording medium claimed in claim 7 wherein the value of the second capacitance C′ is the same as the value of the first mentioned capacitance C.

9. A recording medium claimed in claim 8 wherein the second resistance R′ is expressed as follows:
$${R}^{′} = \frac{{Z}_{0}}{ln ( 2 )} \{ {x}_{0} + {x}_{1} ( m - 1 ) + {{x}_{2} ( m - 1 )}^{2} \}$$
where the dumping factor “m”:
$$m = \frac{R}{2} \sqrt{\frac{C}{L}}$$
$$\begin{matrix}{Z}_{0} = \sqrt{\frac{L}{C}} \\ {x}_{0} = 1.6783 … \\ {x}_{1} = 0.9389 … \\ {x}_{2} = 0.3489 …\end{matrix} .$$

10. A recording medium claimed in claim 9 wherein the dumping factor “m” is in the range of 0.109<m<1.
